(19) United States
(12) Patent Application Publication
(10) Pub. No.: US 2026/0264505 A1
(43) Pub. Date: Sep. 10, 2026

(54) CONVEYANCE ASSISTANCE DEVICE

(71) Applicant: JTEKT MACHINE SYSTEMS CORPORATION, Yao-shi, Osaka (JP)

(72) Inventors: Hiroyuki NIWA, Yao-shi, Osaka (JP); Hiroshi TOMOEDA, Kurume-shi, Fukuoka (JP)

(73) Assignee: JTEKT MACHINE SYSTEMS CORPORATION, Yao-shi, Osaka (JP)

(21) Appl. No.: 19/167,431

(22) PCT Filed: Mar. 4, 2024
(86) PCT No.: PCT/JP2024/008068

§ 371 Date: Sep. 22, 2025

(30) Foreign Application Priority Data
Mar. 22, 2023 (JP) 2023-045885

(51) Int. Cl. B60K 7/00; B60K 1/04

(52) U.S. Cl. CPC B60K 7/0007; B60K 1/04; B60K 2001/0455

(57) ABSTRACT

A transport assistance apparatus is arranged between a front caster and a rear caster of a bed. The transport assistance apparatus includes a first arm member that swings about a first swing axis, a first mecanum wheel supported by the first arm member and has a first axle that swings integrally with the first arm member, and a first spring member that biases the swing of the first arm member. The first spring member has one end connected to the first arm member and the other end arranged in front of or behind the one end and connected to a base member.

### TECHNICAL FIELD

The present disclosure relates to a transport assistance apparatus.

### BACKGROUND ART

For example, Patent Document 1 discloses a mecanum wheel vehicle. The vehicle includes a chassis, at least four mecanum wheels, and coil springs supporting the mecanum wheels on the chassis.

According to Patent Document 1, each coil spring is interposed between the chassis and a corresponding one of the mecanum wheels, and is configured to apply a spring force component in a direction orthogonal to the ground.

### CITATION LIST

### Patent Document

Patent Document 1: Japanese Unexamined Patent Publication No. 2018-504305

### SUMMARY OF THE INVENTION

### Technical Problem

The inventors of the present application studied attaching driving wheels such as the mecanum wheels to a lower portion of a bed with casters to assist the conveyance of the bed. They also considered that the driving wheels are brought into close contact with a road surface of a conveyance path by using spring members such as the coil springs disclosed in Patent Document 1.

After further studies, the inventors of the present application considered a device with the driving wheels and the spring members unitized and arranging the device between front and rear casters of the bed with casters.

However, if the bed with the device arranged as described above runs on a sloping road surface from a flat road surface, the driving wheels may be separated from the road surface, or the contact between the driving wheels and the road surface may be weakened.

One approach that dispels such concerns is increasing the amount of a stroke (particularly, a downward stroke) of the driving wheels by increasing the expansion and contraction of the spring members. However, if the spring members are configured to expand and contract in the vertical direction as in Patent Document 1, the height of the device disadvantageously increases by the increased amount of expansion and contraction of the spring members.

The present disclosure has been made in view of the above circumstances, and an object thereof is to increase the stroke amount of the driving wheels while keeping the height of the device the same as conventional devices.

### Solution to the Problem

A first aspect of the present disclosure is directed to a transport assistance apparatus that assists a hand-propelled movement of a bed having a plurality of casters including a front caster and a rear caster, and is arranged between the front caster and the rear caster in a front-rear direction of the bed. The transport assistance apparatus includes: a base member fixed to a lower portion of the bed; an arm member connected to the base member and swings about a rotation axis extending in a left-right direction of the bed; a driving wheel supported by the arm member and having an axle that swings integrally with the arm member; and a spring member that biases the swing of the arm member to press the driving wheel against a transport surface on which the bed travels. The spring member has one end connected to the arm member and the other end arranged in front of or behind the one end and connected to the base member.

According to the first aspect, the spring member that biases the swing of the arm member is connected to be oriented in the front-rear direction of the bed. Being oriented in this manner, the spring member itself expands and contracts in the front-rear direction while keeping the driving wheel stroking in the vertical direction. By making the stroke direction of the driving wheel and the expansion/contraction direction of the spring member intersect each other, the height of the transport assistance apparatus can be kept the same as conventional transport assistance apparatuss, although the expansion/contraction amount of the spring member is increased to increase the stroke amount of the driving wheel.

According to a second aspect of the present disclosure, the base member may include a pair of front and rear beam-shaped members spanning side frames of the bed, the arm member may be connected to one of the pair of front and rear beam-shaped members, and the other end of the spring member may be connected to the other of the pair of front and rear beam-shaped members.

According to the second aspect, the arm member and the spring member are connected to the pair of beam-shaped members, making the transport assistance apparatus into a unit. Making the transport assistance apparatus into a unit allows easy attachment and detachment of the device to and from the bed. This can improve the usability of the transport assistance apparatus.

According to a third aspect of the present disclosure, the driving wheel, a motor connected to the driving wheel to drive the driving wheel, and a housing box containing a controller for controlling the motor may be arranged between the pair of front and rear beam-shaped members.

According to the third aspect, the transport assistance apparatus can be made into a unit. This allows easy attachment to the bed.

According to a fourth aspect of the present disclosure, the transport assistance apparatus may include a battery that supplies electric power to the motor and the controller. The battery may be arranged outside the housing box, and the battery may be detachably attached to the bed.

According to the fourth aspect, the battery intentionally arranged outside the housing box eliminates the need to remove the housing box from the bed or open or close the housing box for the replacement of the battery. This can improve the usability of the transport assistance apparatus.

According to a fifth aspect of the present disclosure, the spring member may be constituted of a tension spring that contracts to pull the arm member, and the arm member may constitute a bell crank mechanism using the spring member as a driving element and the axle as a driven element.

According to the fifth aspect, the arm member constituting the bell crank mechanism is advantageous in allowing the axle to stroke in the vertical direction using the biasing force of the spring member.

According to a sixth aspect of the present disclosure, the axle may be arranged in front of or behind the rotation axis, a connection portion between the one end of the spring member and the arm member is arranged above the rotation axis, and a distance between the rotation axis and the axle is longer than a distance between the rotation axis and the connection portion in a side view along the left-right direction.

According to the sixth aspect, when the arm member rotates about the rotation axis, the displacement of the axle relative to the rotation axis is larger than the displacement of the connection portion relative to the rotation axis. Thus, when the spring member pulls the connection portion to swing the arm member, the axle can be displaced by an amount equal to or more than the displacement of the connection portion. This is effective in increasing the stroke amount of the driving wheel.

The connection portion is arranged above the rotation axis. Thus, relatively reducing the distance between the rotation axis and the connection portion is effective in keeping the height of the device the same as the conventional device.

According to a seventh aspect of the present disclosure, the arm member may include a connection portion connected to the one end of the spring member and a swing end portion supporting the axle. The spring member is arranged to extend forward or rearward in the front-rear direction from the other end which is a fixed end toward the one end which is a free end, and the arm member is arranged to extend from the connection portion toward the swing end portion in a direction opposite to the spring member in the front-rear direction.

According to the seventh aspect, the arm member extends to be folded back in the front-rear direction with respect to the spring member. This configuration is advantageous in keeping the dimension of the device in the front-rear direction the same as the conventional transport assistance apparatuss while maintaining the stroke amount of the arm member and the driving wheel.

According to an eighth aspect of the present disclosure, the arm member and the spring member may be arranged not to overlap the driving wheel when the transport assistance apparatus is viewed from above.

According to the eighth aspect, the driving wheel and the arm member or the spring member are arranged not to be aligned in the vertical direction. This arrangement is advantageous in keeping the driving wheel stroking in the vertical direction and keeping the height of the device the same as the conventional transport assistance apparatuss.

According to a ninth aspect of the present disclosure, the transport assistance apparatus may be arranged at a center in the front-rear direction of the lower portion of the bed.

As described above, if the bed runs on a sloping road surface from a flat road surface, the driving wheel may be separated from the road surface, or the contact between the driving wheel and the road surface may be weakened. This problem becomes more remarkable when the transport assistance apparatus is arranged at the center in the front-rear direction of the bed with casters. The configuration of the present disclosure is extremely useful in such a situation.

### Advantages of the Invention

As described above, according to the present disclosure, the stroke amount of the driving wheel can be increased while keeping the height of the device the same as conventional devices.

### BRIEF DESCRIPTION OF THE DRAWINGS

FIG. 1 is a side view illustrating a general configuration of a transport assistance apparatus and a bed with casters.

FIG. 2 is a bottom view illustrating the general configuration of the transport assistance apparatus and the bed with casters.

FIG. 3 is a perspective view illustrating the configuration of the transport assistance apparatus.

FIG. 4 is a plan view illustrating the configuration of the transport assistance apparatus.

FIG. 5 is a side view illustrating the configuration of the transport assistance apparatus.

FIG. 6 is a front view illustrating the configuration of the transport assistance apparatus.

FIG. 7 is a side view illustrating an example of a mounting structure of the transport assistance apparatus.

FIG. 8 is a block diagram illustrating a configuration of a control system of the transport assistance apparatus.

FIG. 9 is a schematic view illustrating the configuration of the transport assistance apparatus.

FIG. 10 is a view illustrating how the transport assistance apparatus works when the bed goes over a step.

FIG. 11 is a schematic view illustrating a conventional transport assistance apparatus.

FIG. 12 is a view illustrating a conventional transport assistance apparatus going up a slope.

### DESCRIPTION OF EMBODIMENTS

An embodiment of the present disclosure will be described below with reference to the drawings.

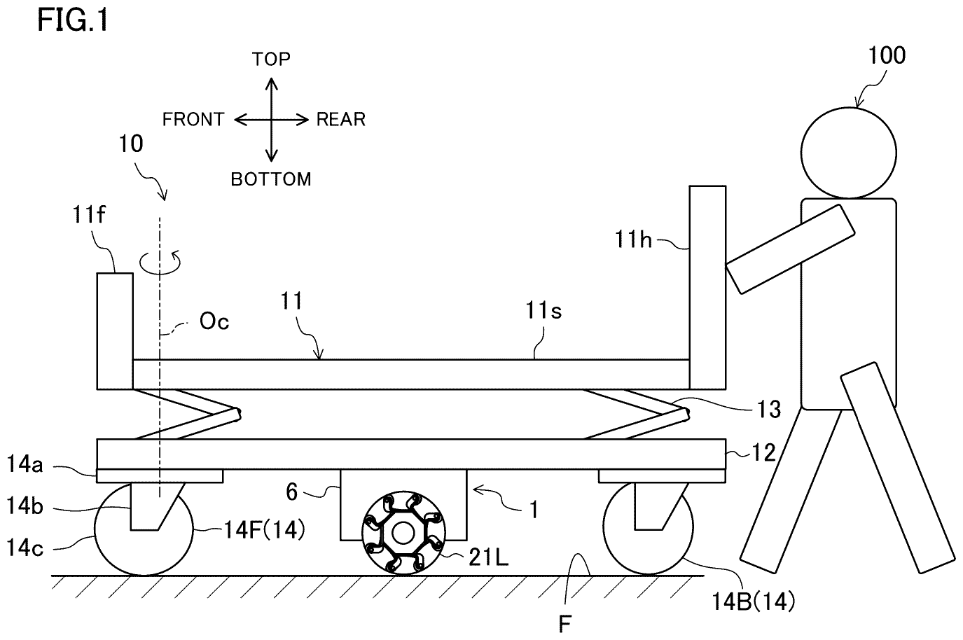

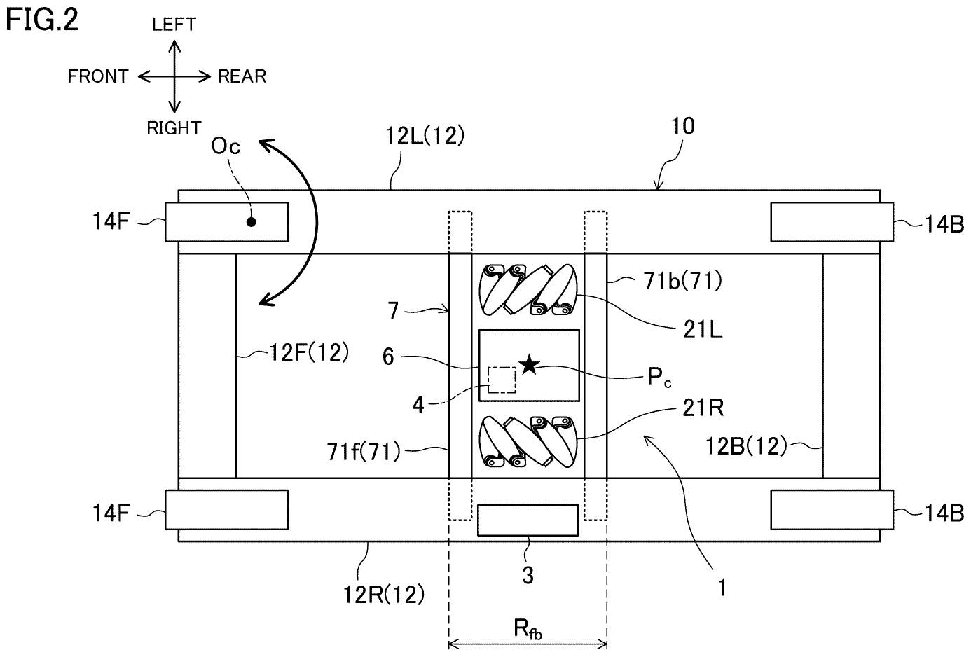

FIG. 1 is a side view illustrating a general configuration of a transport assistance apparatus 1 and a caster bed 10, and FIG. 2 is a bottom view illustrating the general configuration of the transport assistance apparatus 1 and the caster bed 10.

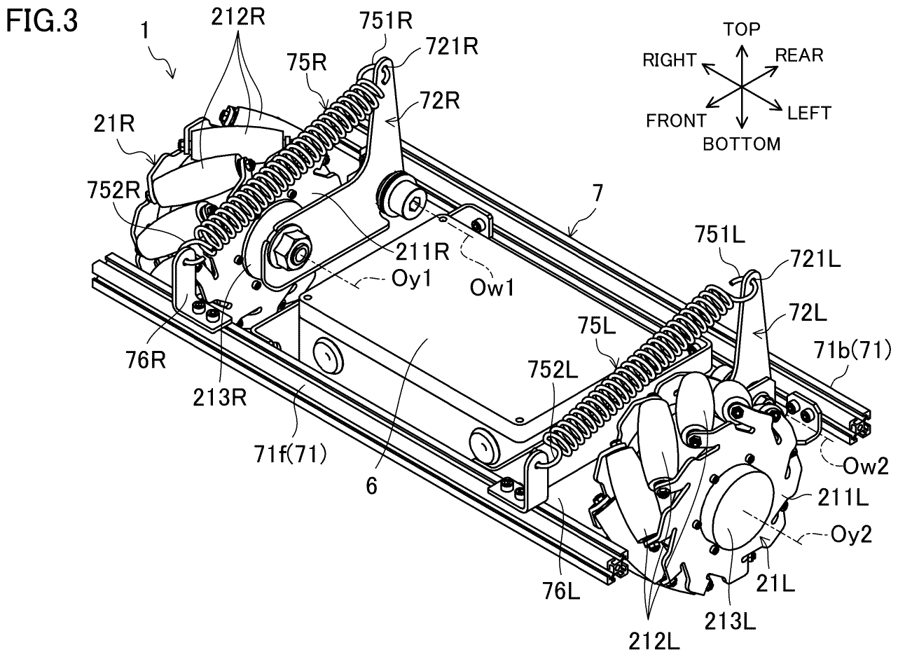

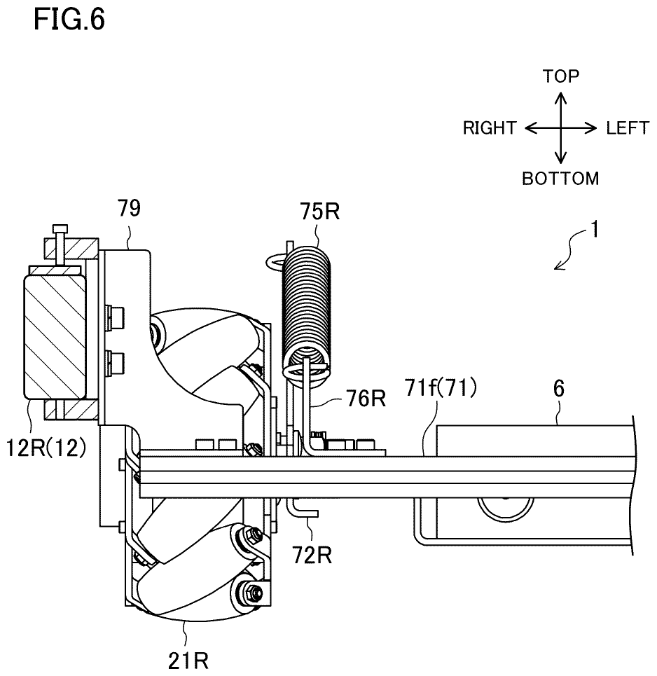

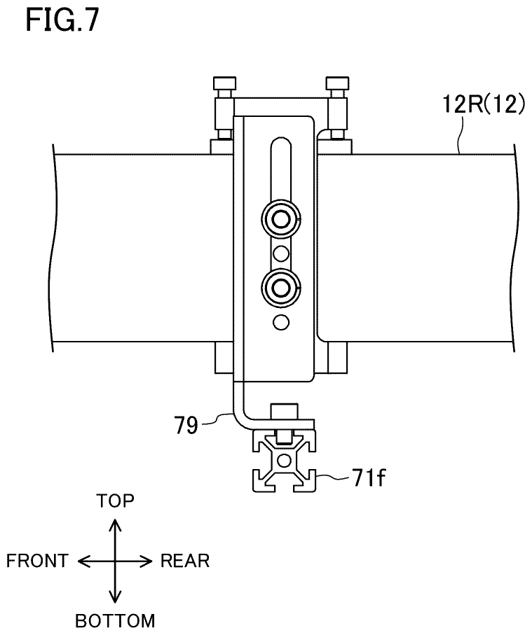

FIGS. 3, 4 and 5 are perspective, plan, and side views illustrating the configuration of the transport assistance apparatus 1. FIG. 6 is a front view illustrating the configuration of the transport assistance apparatus 1, and FIG. 7 is a view illustrating a mounting structure of the transport assistance apparatus 1.

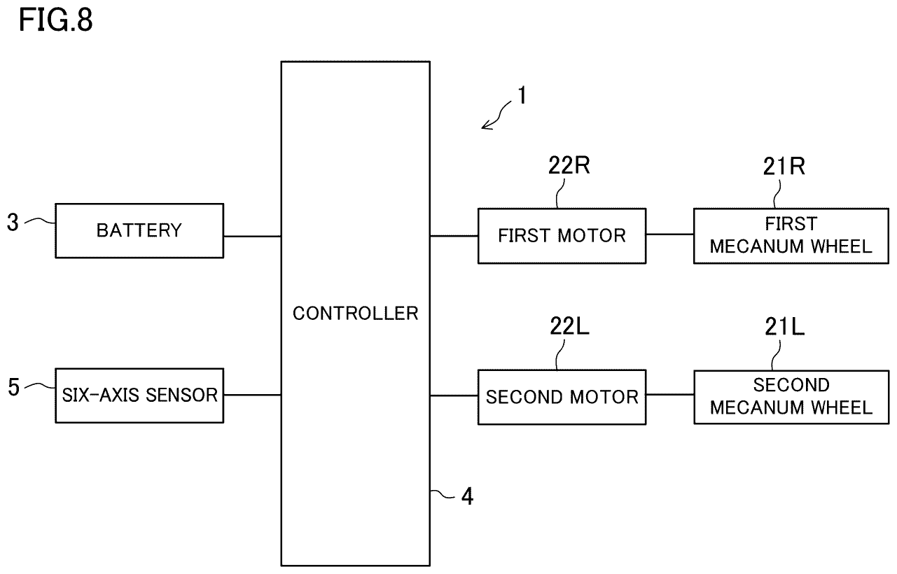

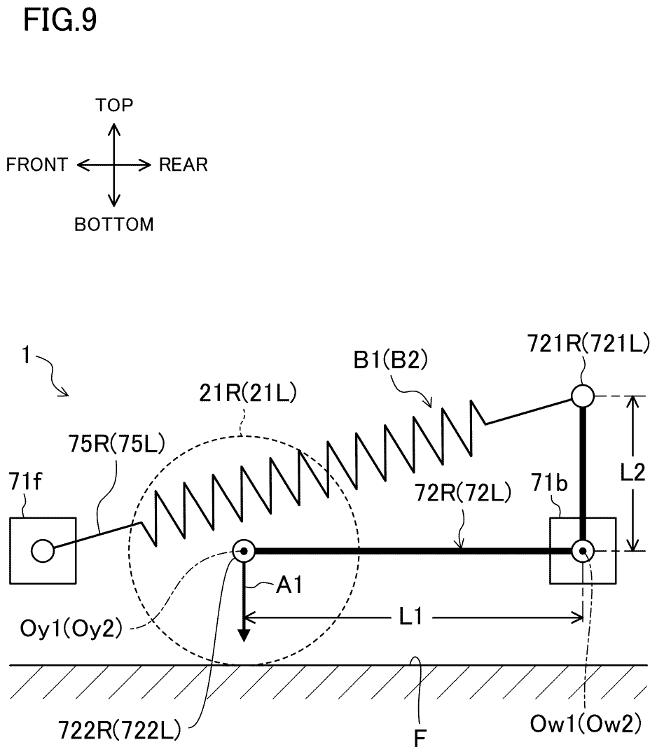

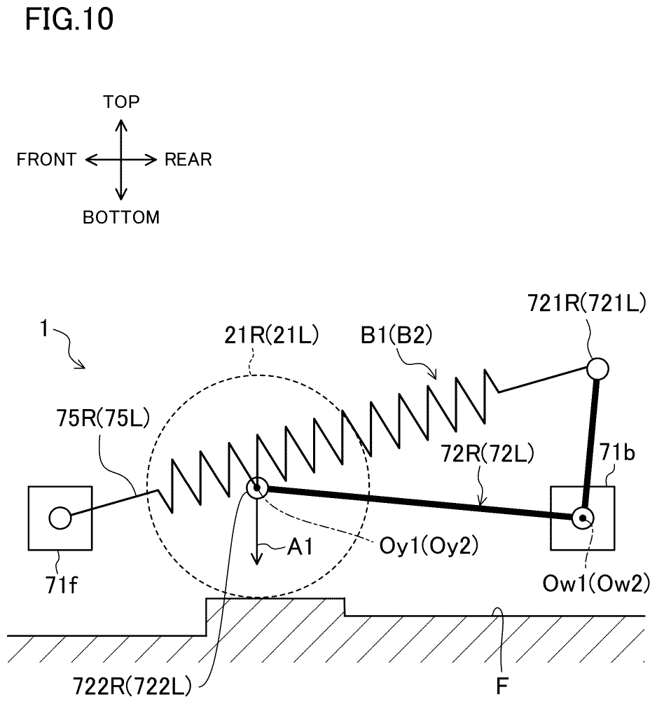

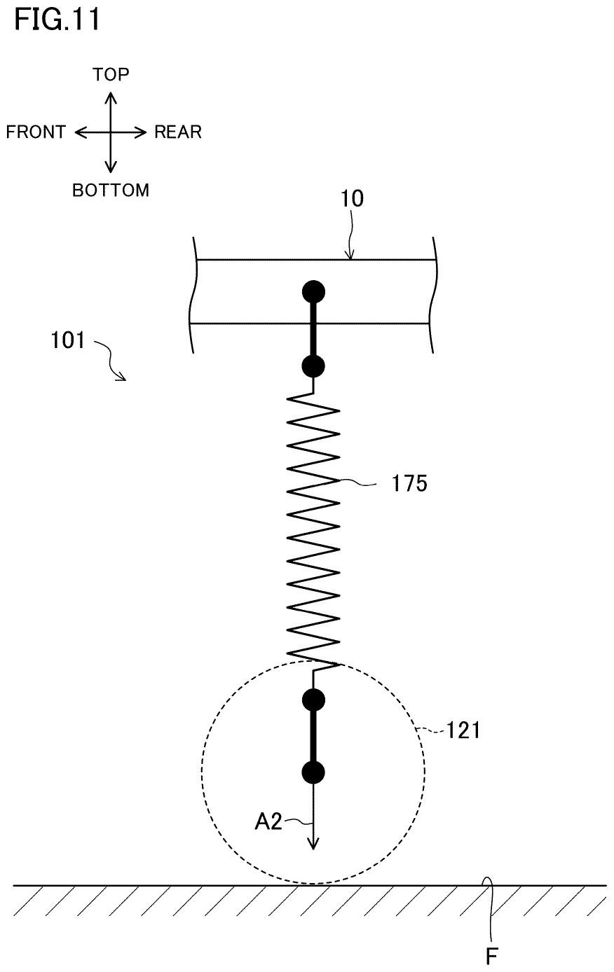

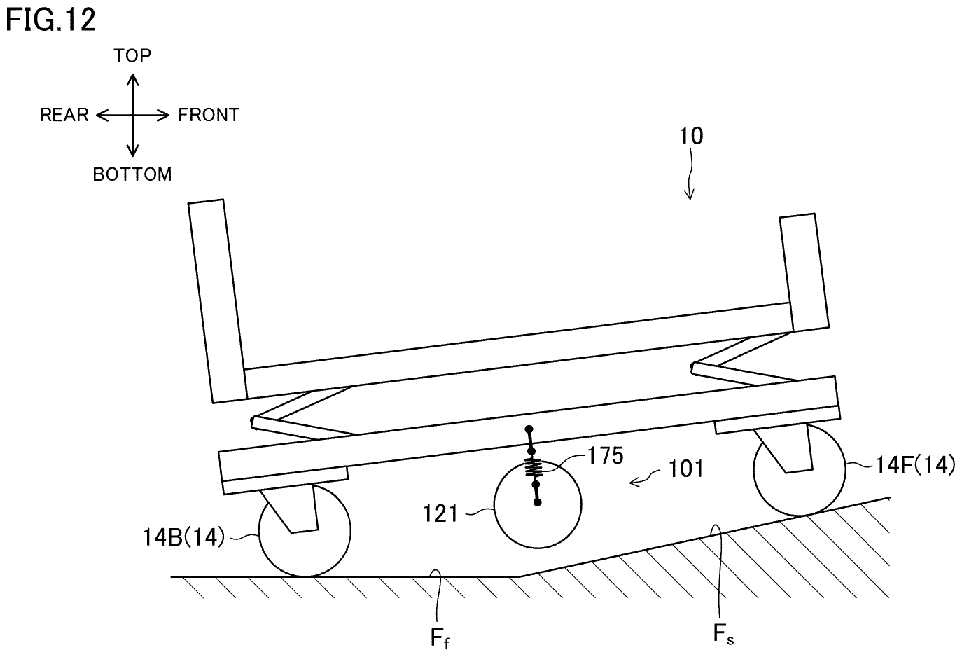

FIG. 8 is a block diagram illustrating the configuration of a control system of the transport assistance apparatus 1, and FIG. 9 is a schematic view illustrating the configuration of the transport assistance apparatus. FIG. 10 is a view illustrating how the transport assistance apparatus 1 works when the bed goes over a step, FIG. 11 is a schematic view illustrating a conventional transport assistance apparatus 101, and FIG. 12 is a view illustrating the conventional transport assistance apparatus 101 going up a slope.

The transport assistance apparatus 1 is attached to an object which is a bed 10 with casters (hereinafter simply referred to as a “bed”). The transport assistance apparatus 1 is a device that assists a hand-propelled movement of the bed 10.

As shown in FIGS. 1 and 2, the bed 10 according to the present embodiment includes a plurality of casters 14 including front casters 14F and rear casters 14B, and is used as a medical bed, for example.

Hereinafter, a lengthwise direction of the bed 10, that is, a direction in which a person lies on the bed 10 is referred to as a “front-rear direction” or a “longitudinal direction,” a direction toward the toes of the person in the front-rear direction is referred to as the “front,” and a direction toward the head of the person is referred to as the “rear.”

Similarly, a widthwise direction of the bed 10, that is, a direction orthogonal to the front-rear direction on a horizontal plane is defined as a “left-right direction” or a “lateral direction,” a direction toward the back of the paper of FIG. 1 in the left-right direction is defined as the “right,” and a direction toward the front of the paper of FIG. 1 is defined as the “left” (see FIG. 2 for details). The “left-right direction” referred to herein means the left-right direction when the bed is viewed from the back side toward the front side. In the following description, a “lateral movement” refers to a movement in the left-right direction. The left-right direction (lateral direction) can also be defined as a direction that is orthogonal to the front-rear direction and extends along a transport surface F (a floor surface on which the bed 10 travels).

The bed 10 is supported by a transporter 100. In the illustrated example, the bed 10 is supported at one end (e.g., a rear end) in the front-rear direction. The transport assistance apparatus 1 operates to assist the transporter 100 supporting the bed 10 to push the bed 10 by hand.

As shown in FIG. 1, the bed 10 includes a bed body 11 on which a mattress (not shown) is placed, a frame 12 that supports the bed body 11 from below, a lifter 13 that raises and lowers the bed body 11 with respect to the frame 12, and a plurality of casters 14 (four casters in the illustrated example) arranged on the bottom of the bed 10. When used as a medical bed, the bed 10 weighs, for example, 60 kg or more and 300 kg or less.

The bed body 11 includes a headboard 11h arranged at a rear end of the bed 10, a footboard 11f arranged at a front end opposite to the rear end in the front-rear direction, and side rails 11s arranged on the left and right sides of the bed 10.

The headboard 11h is supported from the rear side by the transporter 100 to move the bed 10 by hand. The headboard 11h serves as a support to which a force is applied by the transporter 100. A member such as a handle or a grip may be attached to or integrated with the headboard 11h so that the member is used as the support. The footboard 11f or the side rails 11s may serve as the support.

As shown in FIG. 2, the frame 12 is formed in a rectangular frame shape, and includes four sides consisting of a front frame 12F, a right frame 12R, a left frame 12L, and a rear frame 12B.

The front frame 12F is arranged on the front side of the bed 10 and extends in the left-right direction. The right frame 12R is arranged on the right side of the bed 10 and extends in the front-rear direction. The left frame 12L is arranged on the left side of the bed 10 and extends in the front-rear direction. The rear frame 12B is arranged on the rear side of the bed 10 and extends in the left-right direction.

As shown in FIGS. 1 and 2, the front casters 14F and the rear casters 14B constituting the casters 14 are arranged at four corners of the bottom of the bed 10. Two front casters 14F are arranged in the left-right direction, and two rear casters 14B are also arranged in the left-right direction. The casters 14 support the frame 12, the lifter 13, and the bed body 11 with respect to the transport surface F.

Each caster 14 is a so-called free caster, and includes a mount 14a fixed to the bottom of the bed 10, a fork 14b that can swivel about a swivel axis Oc relative to the mount 14a, and a wheel 14c rotatably supported by the fork 14b. The swivel axis Oc of each fork 14b extends vertically (along the height of the bed 10). A rotation axis of each wheel 14c extends along a horizontal plane. The rotation axis is inclined with respect to the left-right direction when the fork 14b swivels relative to the mount 14a.

The transport assistance apparatus 1 is arranged between the front casters 14F and the rear casters 14B in the front-rear direction of the bed 10 to assist the hand-propelled movement of the bed 10. Specifically, the transport assistance apparatus 1 is arranged at the center in the front-rear direction of the lower portion of the bed 10. The phrase “arranged at the center in the front-rear direction” as used herein means that a front-rear center position Pc of the bed 10 is within a range R_{fb} between the front and rear ends of the transport assistance apparatus 1 as shown in FIG. 2.

More specifically, the transport assistance apparatus 1 is arranged to span a middle portion of the right frame 12R in the front-rear direction and a middle portion of the left frame L in the front-rear direction. The transport assistance apparatus 1 is arranged between the front casters 14F and the rear casters 14B in the front-rear direction and at the center of the bed 10 in the left-right direction.

As shown in FIGS. 1 to 8, the transport assistance apparatus 1 includes a housing box 6, a fixture 7, first and second mecanum wheels 21R and 21L as driving wheels, first and second motors 22R and 22L, a battery 3, a controller 4, and a six-axis sensor 5 (the first and second motors 22R and 22L and the six-axis sensor 5 are shown only in FIG. 8). It is assumed that, of the first and second mecanum wheels 21R and 21L, the first mecanum wheel 21R is located on the right, and the second mecanum wheel 21L is located on the left.

Among these components, the controller 4 and the six-axis sensor 5 are contained in the housing box 6, and the battery 3, the fixture 7, the first and second mecanum wheels 21R and 21L, and the first and second motors 22R and 22L are arranged outside the housing box 6.

As shown in FIGS. 1 and 2, the first and second mecanum wheels 21R and 21L are attached to a lower portion (bottom) of the bed 10. The first and second mecanum wheels 21R and 21L are in contact with the transport surface F of the bed 10 (see FIGS. 1 and 9 for the transport surface F). The first and second mecanum wheels 21R and 21L are arranged behind the front casters 14F and in front of the rear casters 14B. In the present embodiment, the first and second mecanum wheels 21R and 21L are arranged side by side in the left-right direction which is the widthwise direction, as shown in FIG. 2.

Specifically, as shown in FIGS. 3 to 5, the first mecanum wheel 21R includes a first axle 213R that rotates about a first rotation axis Oy1, a first wheel body 211R that rotates integrally with the first axle 213R, and a plurality of first barrel-shaped rollers 212R that are arranged along an outer periphery of the first wheel body 211R and rotate about a first inclined axis Or inclined with respect to the first rotation axis Oy1.

The second mecanum wheel 21L includes a second axle 213L that rotates about a second rotation axis Oy2, a second wheel body 211L that rotates integrally with the second axle 213L, and a plurality of second barrel-shaped rollers 212L that are arranged along an outer periphery of the second wheel body 211L and rotate about a second inclined axis Ol inclined in a direction different from the first inclined axis Or with respect to the second rotation axis Oy2.

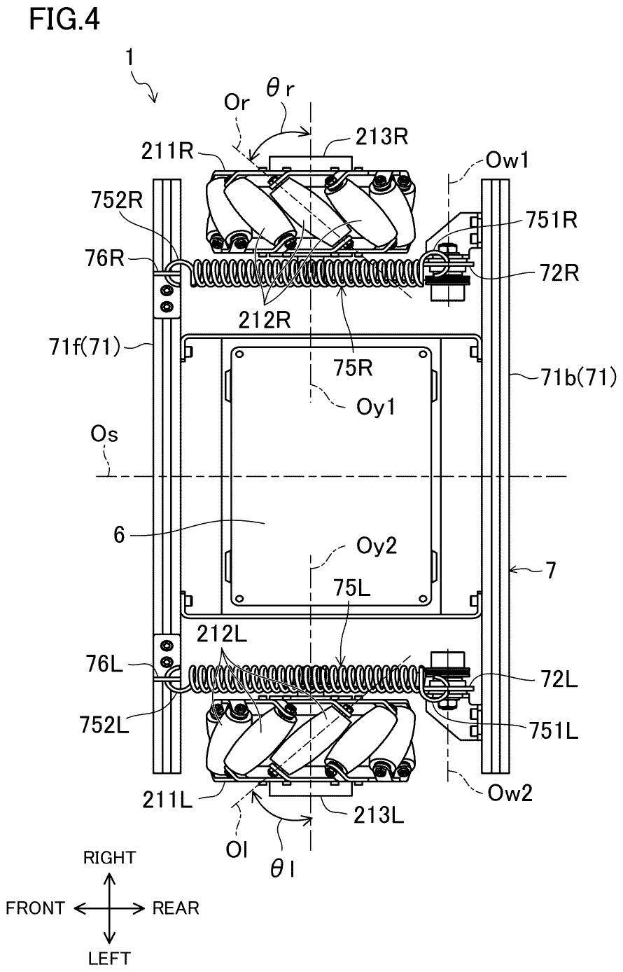

Both the first and second rotation axes Oy1 and Oy2 extend in the left-right direction. The first inclined axis Or is inclined to be line-symmetrical with the second inclined axis Ol with respect to the front-rear direction (see a symmetry axis Os shown in FIG. 4). In other words, suppose that a plane extending in the vertical direction and the front-rear direction is a mirror plane, the first inclined axis Or and the second inclined axis Ol extend to be mirror-symmetrical with respect to the mirror plane.

When viewed from above as shown in FIG. 4 (when viewed in plan), the first and second inclined axes Or and Ol extend from the inside to the outside in the left-right direction (from the center portion in the left-right direction to the right or the left) as they extend from the rear side to the front side in the front-rear direction.

More specifically, an inclination angle Or of the first inclined axis Or with respect to the first rotation axis Oy1 is 45° in plan view. Similarly, an inclination angle θl of the second inclined axis O1 with respect to the second rotation axis Oy2 is also 45° in plan view. The direction and angle of inclination of each of the barrel-shaped rollers 212R and 212L are not limited to these examples. For example, the entire transport assistance apparatus 1 shown in FIG. 2 may be rotated by a predetermined angle about a z-axis extending in the vertical direction.

As will be described later, the first and second mecanum wheels 21R and 21L are mutually connected via a base member 71 shown in FIG. 3 and some other drawings. Thus, the first and second mecanum wheels 21R and 21L integrally move in the front-rear direction and the left-right direction and integrally turn around a turning axis perpendicular to a horizontal plane.

The first and second motors 22R and 22L are respectively connected to the first and second mecanum wheels 21R and 21L to drive the first and second mecanum wheels 21R and 21L. In particular, each of the first and second motors 22R and 22L is configured as a so-called three-phase DC brushless motor. Both the first and second motors 22R and 22L are electrically connected to the controller 4, and are controlled by the controller 4.

A motor current corresponding to a torque load is supplied to each of the first and second motors 22R and 22L to rotate them. The motor current can change the rotational speeds of the first and second motors 22R and 22L, and can achieve switching between the forward and reverse rotations.

The first motor 22R is connected to the first mecanum wheel 21R to be able to transmit a driving force (torque) to the first mecanum wheel 21R. The second motor 22L is connected to the second mecanum wheel 21L to be able to transmit a driving force (torque) to the second mecanum wheel 21L.

When the first motor 22R rotates, the driving force is transmitted to rotate the first mecanum wheel 21R. Similarly, when the second motor 22L rotates, the driving force is transmitted to rotate the second mecanum wheel 21L.

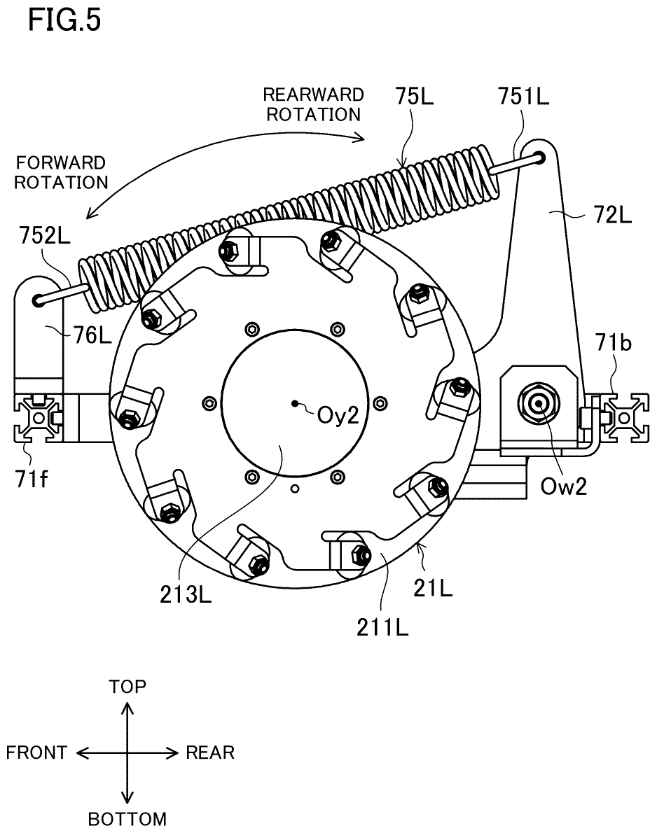

In the present embodiment, the forward rotation of the first motor 22R rotates the first mecanum wheel 21R forward, and the reverse rotation of the first motor 22R rotates the first mecanum wheel 21R backward. Similarly, in the present embodiment, the forward rotation of the second motor 22L rotates the second mecanum wheel 21L forward, and the reverse rotation of the second motor 22L rotates the second mecanum wheel 21L backward (see also FIG. 5).

The first motor 22R is incorporated in the first mecanum wheel 21R, and the second motor 22L is incorporated in the second mecanum wheel 21L. Incorporating the first and second motors 22R and 22L in this manner makes the entire transport assistance apparatus 1 simple and compact.

The battery 3 supplies electric power to the first and second motors 22R and 22L and the controller 4. The battery 3 of the present embodiment is constituted of, for example, a lithium ion battery. The battery 3 is arranged outside the housing box 6, for example, below the frame 12. The battery 3 is detachably attached to the bed 10. Thus, only the battery 3 can be removed and charged without removing the entire transport assistance apparatus 1 from the bed 10.

The controller 4 controls the first and second motors 22R and 22L based on an electric signal inputted from the six-axis sensor 5. The controller 4 includes a CPU, memory, and an input/output bus, and is constituted of, for example, a control board.

The controller 4 determines the direction and magnitude of the force (external force) applied by the transporter 100 based on the electric signal inputted from the six-axis sensor 5. The controller 4 calculates and commands the rotational speed of each of the first and second motors 22R and 22L based on the determination, and drives the first and second motors 22R and 22L at the commanded rotational speeds. The controller 4 drives the first and second motors 22R and 22L to rotate the first and second mecanum wheels 21R and 21L forward and/or backward.

At this time, the direction and speed of the rotation of each of the first and second mecanum wheels 21R and 21L are controlled to exert thrust in the direction in which the external force acts. This thrust can assist the hand-propelled movement of the bed 10.

The housing box 6 is assembled to the fixture 7 together with the first and second mecanum wheels 21R and 21L, and is attached to the lower portion of the bed 10 with the fixture 7. The fixture 7 is detachably attached to the lower portion of the bed 10. That is, the transport assistance apparatus 1 of the present embodiment can be retrofitted to the bed 10 and can be removed as necessary.

As shown in FIGS. 2 to 7, the fixture 7 of the present embodiment includes a base member 71, first and second arm members 72R and 72L, first and second spring members 75R and 75L, and first and second brackets 76R and 76L.

The first and second arm members 72R and 72L, the first and second spring members 75R and 75L, and the first and second brackets 76R and 76L are each configured to be mirror-symmetrical with respect to the plane passing through the symmetry axis Os shown in FIG. 4, similarly to the first and second mecanum wheels 21L and 21R.

As shown in FIGS. 2, 6, and 7, the base member 71 is fixed to the lower portion of the bed 10 via a base bracket 79. The base member 71 includes a pair of front and rear beam-shaped members. As shown in FIG. 2, the base member 71 including the pair of beam-shaped members spans the side frames (the right frame 12R and the left frame 12L) of the bed 10. Hereinafter, of the pair of front and rear beam-shaped members, the beam-shaped member on the front side is referred to as a front base member 71f, and the beam-shaped member on the rear side is referred to as a rear base member 71b.

The front base member 71f and the rear base member 71b are spaced in the front-rear direction, and each of the front base member 71f and the rear base member 71b spans a central portion of the right frame 12R in the front-rear direction and a central portion of the left frame 12L in the front-rear direction. As shown in FIGS. 3 to 5, the front base member 71f and the rear base member 71b are arranged at substantially the same height, and are parallel to each other in the lateral direction.

The base bracket 79 attaches the front base member 71f and the rear base member 71b to the right frame 12R and the left frame 12L. The base bracket 79 is detachably attached to the right frame 12R and the left frame 12L. In the present embodiment, the front base member 71f and the rear base member 71b are located below the right frame 12R and the left frame 12L.

As shown in FIG. 4, the first and second mecanum wheels 21R and 21L, the first and second motors 22R and 22L, and the housing box 6 are arranged between the front base member 71f and the rear base member 71b which are the pair of beam-shaped members.

The first and second arm members 72R and 72L as the arm members are connected to the base member 71. Of the first and second arm members 72R and 72L, the first arm member 72R on the right side in FIGS. 3 and 4 and some other drawings swings about a first swing axis (rotation axis) Ow1 extending in the left-right direction. Similarly, the second arm member 72L on the left side in FIGS. 3 and 4 and some other drawings swings about a second swing axis (rotation axis) Ow2 extending in the left-right direction. As shown in FIG. 4, in the present embodiment, the first swing axis Ow1 and the second swing axis Ow2 are coaxial.

Specifically, the first and second arm members 72R and 72L are formed of plate-shaped members extending in the front-rear direction and the vertical direction. More specifically, the first and second arm members 72R and 72L are formed to have a larger dimension in the front-rear direction than in the vertical direction.

More specifically, as shown in FIG. 3, each of the first and second arm members 72R and 72L of the present embodiment has a long side extending in the front-rear direction and a short side extending in the vertical direction, and is formed in a sideways L-shape.

Further, both the first and second arm members 72R and 72L are connected to one of the front base member 71f and the rear base member 71b (the rear base member 71b in the present embodiment).

As shown in FIG. 3, the center of the first swing axis Ow1 is located behind a front end portion of the first arm member 72R and below an upper end portion of the first arm member 72R. The first swing axis Ow1 according to the present embodiment is located at a corner portion of the L-shaped first arm member 72R where the long side and the short side intersect. The front end portion of the first arm member 72R supports the first axle 213R and functions as a swing end portion that is displaced more than the other portion when the first arm member 72R swings. This portion will be referred to as a “first swing end portion 722R” (shown only in FIG. 9).

Similarly, as shown in FIG. 3, the center of the second swing axis Ow2 is located behind a front end portion of the second arm member 72L and below an upper end portion of the second arm member 72L. The second swing axis Ow2 according to the present embodiment is located at a corner portion of the L-shaped second arm member 72L where the long side and the short side intersect. The front end portion of the second arm member 72L supports the second axle 213L and functions as a swing end portion that is displaced more than the other portion when the second arm member 72L swings. This portion will be referred to as a “second swing end portion 722L” (shown only in FIG. 9).

Each of the first swing axis Ow1 and the second swing axis Ow2 is located between the front base member 71f and the rear base member 71b in the front-rear direction, and at substantially the same height as the front base member 71f and the rear base member 71b in the vertical direction.

As shown in FIGS. 3 and 4, the first arm member 72R supports the first mecanum wheel 21R. Specifically, the front end portion of the first arm member 72R supports the first mecanum wheel 21R via the first axle 213R. This support structure allows the first axle 213R to swing integrally with the first arm member 72R.

In particular, in the present embodiment, the first axle 213R and the first rotation axis Oy1 as the rotation center of the first axle 213R are arranged in front of the first swing axis Ow1 and the second swing axis Ow2 and behind the front base member 71f in the front-rear direction. The first axle 213R may be arranged behind the first swing axis Ow1 and the second swing axis Ow2 and in front of the rear base member 71b.

Similarly, as shown in FIGS. 3 and 4, the second arm member 72L supports the second mecanum wheel 21L. Specifically, the front end portion of the second arm member 72L supports the second mecanum wheel 21L via the second axle 213L. This support structure allows the second axle 213L to swing integrally with the second arm member 72L.

In particular, in the present embodiment, the second axle 213L and the second rotation axis Oy2 as the rotation center of the second axle 213L are arranged in front of the first swing axis Ow1 and the second swing axis Ow2 and behind the front base member 71f in the front-rear direction. The second axle 213L may be arranged behind the first swing axis Ow1 and the second swing axis Ow2 and in front of the rear base member 71b.

As shown in FIGS. 9 and 10, the first spring member 75R biases the swing of the first arm member 72R to press the first mecanum wheel 21R against the transport surface F. This swing causes the front end portion of the first arm member 72R to turn downward. The first spring member 75R according to the present embodiment is constituted of a tension spring that contracts to pull the first arm member 72R, particularly the upper end portion of the first arm member 72R.

Returning to FIGS. 3 to 5, the first spring member 75R has one end 751R connected to the first arm member 72R and the other end 752R arranged in front of or behind the one end 751R and connected to the base member 71. The first spring member 75R extends obliquely downward from the one end 751R to the other end 752R in the front-rear direction. The one end 751R of the first spring member 75R functions as a free end of the first spring member 75R. The other end 752R of the first spring member 75R functions as a fixed end of the first spring member 75R.

In the present embodiment, the one end 751R of the first spring member 75R is a rear end of the first spring member 75R. The one end 751R is connected to the upper end portion of the first arm member 72R. The upper end portion will be hereinafter referred to as a “first connection portion” and is denoted by a reference character “721R” (see FIGS. 3 and 9). As shown in FIG. 3, the first connection portion 721R according to the present embodiment is located above the first swing axis Ow1 and the second swing axis Ow2 which are the rotation axes.

The other end 752R of the first spring member 75R is a front end of the first spring member 75R arranged in front of the one end 751R. The other end 752R is connected to the other of the front base member 71f and the rear base member 71b (the front base member 71f in the present embodiment). The other end 752R is connected to the front base member 71f via the first bracket 76R fixed to the front base member 71f. A connection position of the first spring member 75R and the first bracket 76R is lower than a connection position between the first spring member 75R and the first arm member 72R.

As shown in FIG. 4, the first arm member 72R and the first spring member 75R are arranged not to overlap the first mecanum wheel 21R when the transport assistance apparatus 1 is viewed from above. As also shown in FIG. 4, the first arm member 72R and the first spring member 75R are arranged between the first mecanum wheel 21R and the housing box 6 in the left-right direction. The first mecanum wheel 21R is arranged on the right of the first arm member 72R, the first spring member 75R, and the housing box 6.

Similarly, as shown in FIG. 9 and some other drawings, the second spring member 75L biases the swing of the second arm member 72L to press the second mecanum wheel 21L against the transport surface F. This swing causes the front end portion of the second arm member 72L to turn downward. The second spring member 75L according to the present embodiment is constituted of a tension spring that contracts to pull the second arm member 72L, particularly the upper end portion of the second arm member 72L.

Returning to FIGS. 3 to 5, the second spring member 75L has one end 751L connected to the second arm member 72L and the other end 752L arranged in front of or behind the one end 751L and connected to the base member 71. The second spring member 75L extends obliquely downward from the one end 751L to the other end 752L in the front-rear direction. The one end 751L of the second spring member 75L functions as a free end of the second spring member 75L. The other end 752L of the second spring member 75L functions as a fixed end of the second spring member 75L.

In the present embodiment, the one end 751L of the second spring member 75L is a rear end of the second spring member 75L. The one end 751L is connected to the upper end portion of the second arm member 72L. The upper end portion will be hereinafter referred to as a “second connection portion” and is denoted by a reference character “721L” (see FIGS. 3 and 9). As shown in FIG. 3, the second connection portion 721L according to the present embodiment is located above the first swing axis Ow1 and the second swing axis Ow2 which are the rotation axes.

The other end 752L of the second spring member 75L is a front end of the second spring member 75L arranged in front of the one end 751L. The other end 752L is connected to the other of the front base member 71f and the rear base member 71b (the front base member 71f in the present embodiment). The other end 752R is connected to the front base member 71f via the second bracket 76L fixed to the front base member 71f. A connection position of the second spring member 75L and the second bracket 76L is lower than a connection position between the second spring member 75L and the second arm member 72L.

As shown in FIG. 4, the second arm member 72L and the second spring member 75L are arranged not to overlap the second mecanum wheel 21L when the transport assistance apparatus 1 is viewed from above. As also shown in FIG. 4, the second arm member 72L and the second spring member 75L are arranged between the second mecanum wheel 21L and the housing box 6 in the left-right direction. The second mecanum wheel 21L is arranged on the left of the second arm member 72L, the second spring member 75L, and the housing box 6.

As shown in FIG. 9, it can be considered that the first arm member 72R constitutes a first bell crank mechanism B1 using the first spring member 75R as a driving element and the first axle 213R as a driven element. That is, when the one end 751R of the first spring member 75R pulls the first connection portion 721R, the first arm member 72R is biased to swing about the first swing axis Ow1. This bias acts in a direction in which the first axle 213R is pressed against the transport surface F as indicated by an arrow A1 in FIG. 9. This bias can press the first mecanum wheel 21R against the transport surface F.

In relation to the configuration of the first bell crank mechanism B1, in a side view along the left-right direction, a distance L1 between the first swing axis Ow1 and the front end portion of the first arm member 72R (more specifically, a distance from the first swing axis Ow1 to the first axle 213R and the first rotation axis Oy1) is longer than a distance L2 between the first swing axis Ow1 and the first connection portion 721R.

The first spring member 75R is arranged to extend forward or rearward in the front-rear direction (rearward in the present embodiment) from the other end 752R as the fixed end toward the one end 751R as the free end. The first arm member 72R extends from the first connection portion 721R toward the first swing end portion 722R in a direction opposite to the first spring member 75R in the front-rear direction (forward in the present embodiment).

The first arm member 72R and the first spring member 75R function as a suspension. This function enables the bed to easily go over the step on the transport surface F. For example, when the bed goes over a step on the transport surface F as shown in FIG. 10, the first arm member 72R rotates in a direction against the biasing force indicated by the arrow Al (a direction away from the transport surface F). At this time, the biasing force is still acting, keeping the first mecanum wheel 21R and the transport surface F in contact.

The same applies to the second arm member 72L. It can be considered that the second arm member 72L constitutes a second bell crank mechanism B2 using the second spring member 75L as a driving element and the second axle 213L as a driven element. The biasing direction of the bell crank mechanism B2 is the same as the biasing direction of the first arm member 72R.

In relation to the configuration of the second bell crank mechanism B2, in a side view along the left-right direction, a distance L1 between the second swing axis Ow2 and the front end portion of the second arm member 72L (more specifically, a distance from the second swing axis Ow2 to the second axle 213L and the second rotation axis Oy2) is longer than a distance L2 between the second swing axis Ow2 and the second connection portion 721L in a side view. The second spring member 75L is arranged to extend forward or rearward in the front-rear direction (rearward in the present embodiment) from the other end 752L as the fixed end toward the one end 751L as the free end. The second arm member 72L extends from the second connection portion 721L toward the second swing end portion 722L in a direction opposite to the second spring member 75L in the front-rear direction (forward in the present embodiment).

As shown in FIG. 11, in a known transport assistance apparatus 101, pressing a driving wheel 121 against the transport surface F using a spring member 175 extending in the vertical direction has been studied.

The inventors of the present application further studied and considered placing a unitized transport assistance apparatus 101 between the front casters 14F and the rear casters 14B of the bed 10 (see FIG. 12).

However, if the transport assistance apparatus 101 is configured and arranged as shown in FIGS. 11 and 12, and the bed runs on a sloping road surface Fs from a flat road surface Ff, the driving wheel 121 could be separated from the road surface (particularly, from a boundary between the flat road surface Ff and the sloping road surface Fs) as shown in FIG. 12, or the contact between the driving wheel 121 and the road surface could be weakened.

One approach that dispels such concerns is increasing the amount of a stroke (particularly, a downward stroke) of the driving wheel 121 by increasing the expansion and contraction of the spring member 175. However, if the spring member 175 is configured to be expanded and contracted in the vertical direction as illustrated in FIGS. 11 and 12, the height of the transport assistance apparatus 101 disadvantageously increases by the increased amount of expansion and contraction of the spring member 175.

In contrast, according to the embodiment, the first spring member 75R that biases the swing of the first arm member 72R is connected to be oriented in the front-rear direction of the bed 10 (see FIGS. 9 and 10 and some other drawings). Being oriented in this manner, the first spring member 75R itself expands and contracts in the front-rear direction while keeping the first mecanum wheel 21R as the driving wheel stroking vertically. By making the stroke direction of the first mecanum wheel 21R and the expansion/contraction direction of the first spring member 75R intersect each other, the height of the transport assistance apparatus can be kept the same as the conventional transport assistance apparatus 101, although the expansion/contraction amount of the first spring member 75R is increased to increase the stroke amount of the first mecanum wheel 21R.

As described with reference to FIGS. 3 to 5, the first arm member 72R and the first spring member 75R are connected to the base member 71 including the pair of beam-shaped members, making the transport assistance apparatus 1 into a unit. Making the transport assistance apparatus into a unit allows easy attachment and detachment of the device to and from the bed 10. This can improve the usability of the transport assistance apparatus 1.

Further, as shown in FIG. 4, the first and second mecanum wheels 21R and 21L, the first and second motors 22R and 22L, and the housing box 6 are arranged between the front base member 71f and the rear base member 71b, making the transport assistance apparatus 1 into a unit. This facilitates the attachment of the device to the bed 10.

In addition, as shown in FIG. 2, the battery 3 intentionally arranged outside the housing box 6 eliminates the need to remove the housing box 6 from the bed 10 or open or close the housing box 6 for the replacement of the battery 3. This improves the usability of the transport assistance apparatus 1.

Further, the first arm member 72R constituting the bell crank mechanism B1 as shown in FIGS. 9 and 10 is advantageous in allowing the first axle 213R to stroke in the vertical direction using the biasing force of the first spring member 75R.

As shown in FIG. 4, the first mecanum wheel 21R and the first arm member 72R or the first spring member 75R are arranged not to be aligned in the vertical direction. This arrangement is advantageous in keeping the first mecanum wheel 21R stroking in the vertical direction and keeping the height of the transport assistance apparatus 1 the same as the conventional devices.

As shown in the side view of FIG. 9, the distance L1 between the first swing axis Ow1 and the first axle 213R is longer than the distance L2 between the first swing axis Ow1 and the first connection portion 721R.

With this configuration, when the first arm member 72R swings about the first swing axis Ow1, the displacement of the first axle 213R relative to the first swing axis Ow1 (particularly, the displacement in the vertical direction) is larger than the displacement of the first connection portion 721R relative to the first swing axis Ow1 (particularly, the displacement in the front-rear direction). Thus, when the first spring member 75R pulls the first connection portion 721R to swing the first arm member 72R, the first axle 213R can be displaced by an amount equal to or more than the displacement of the first connection portion 721R. This is effective in increasing the stroke amount of the first mecanum wheel 21R.

As shown in FIG. 9, the first arm member 72R extends to be folded back in the front-rear direction with respect to the first spring member 75R. This configuration is advantageous in keeping the dimension of the transport assistance apparatus the same as the conventional transport assistance apparatus 101 in the front-rear direction while maintaining the stroke amount of the first arm member 72R and the first mecanum wheel 21R.

As described with reference to FIG. 12, when the bed runs on the sloping road surface Fs from the flat road surface Ff, the driving wheel 121 may be separated from the road surfaces Ff and Fs as shown in FIG. 12, or the contact between the driving wheel 121 and the road surfaces Ff and Fs may be weakened. This problem becomes more remarkable when the transport assistance apparatus 1 is arranged at the center in the front-rear direction of the bed 10. The configuration according to the embodiment is extremely useful under such a situation.

### Other Embodiments

Although the first and second mecanum wheels 21R and 21L are used as the driving wheels in the above embodiment, this configuration is not essential. The present disclosure can also be applied to other driving wheels than the mecanum wheels, such as omni wheels. The number of driving wheels is not limited to two. For example, when the mecanum wheels are used as in the present embodiment, four mecanum wheels may be used. When the omni wheels are employed, three or four omni wheels may be used. The number of motors may be changed according to the number of driving wheels.

### DESCRIPTION OF REFERENCE CHARACTERS

1 Transport Assistance Apparatus
10 Bed (Bed with Casters)
12 Frame
12R Right Frame (Side Frame)
12L Left Frame (Side Frame)
14F Front Caster (Caster)
14B Rear Caster (Caster)
21R First Mecanum Wheel (Driving Wheel)
213R First Axle (Axle)
21L Second Mecanum Wheel (Driving Wheel)
213L Second Axle (Axle)
22R First Motor (Motor)
22L Second Motor (Motor)
3 Battery
4 Controller
6 Housing Box
71 Base Member
71B Rear Base Member (One of Pair of Beam-Shaped Members)
71F Front Base Member (Other of Pair of Beam-Shaped Members)
72R First Arm Member (Arm Member)
721R First Connection Portion (Connection Portion)
722R First Swing End Portion (Swing End Portion)
72L Second Arm Member (Arm Member)
721L Second Connection Portion (Connection Portion)
722L Second Swing End Portion (Swing End Portion)
75R First Spring Member (Spring Member, Tension Spring)
751R One End
752R Other End
75L Second Spring Member (Spring Member, Tension Spring)
751L One End
752L Other End
B1 Bell Crank Mechanism
B2 Bell Crank Mechanism
F Transport Surface
L1 Distance (Distance between Rotation Axis and Axle)
L2 Distance (Distance between Rotation Axis and Connection Portion)
Ow1 First Swing Axis (Rotation Axis)
Ow2 Second Swing Axis (Rotation Axis)

1. A transport assistance apparatus that assists a hand-propelled movement of a bed having a plurality of casters including a front caster and a rear caster, and is arranged between the front caster and the rear caster in a front-rear direction of the bed, the transport assistance apparatus comprising:
a base member fixed to a lower portion of the bed;
an arm member connected to the base member and swinging about a rotation axis extending in a left-right direction of the bed;
a driving wheel supported by the arm member and having an axle that swings integrally with the arm member; and
a spring member that biases the swing of the arm member to press the driving wheel against a transport surface on which the bed travels,
wherein
the spring member includes
one end connected to the arm member and
the other end arranged in front of or behind the one end and connected to the base member.

2. The transport assistance apparatus of claim 1, wherein
the base member includes a pair of front and rear beam-shaped members spanning side frames of the bed,
the arm member is connected to one of the pair of front and rear beam-shaped members, and
the other end of the spring member is connected to the other of the pair of front and rear beam-shaped members.

3. The transport assistance apparatus of claim 2, wherein the driving wheel,
a motor connected to the driving wheel to drive the driving wheel, and
a housing box containing a controller for controlling the motor are arranged between the pair of front and rear beam-shaped members.

4. The transport assistance apparatus of claim 3, further comprising:
a battery that supplies electric power to the motor and the controller,
wherein
the battery is arranged outside the housing box, and
the battery is detachably attached to the bed.

5. The transport assistance apparatus of claim 1, wherein
the spring member is constituted of a tension spring that contracts to pull the arm member, and
the arm member constitutes a bell crank mechanism using the spring member as a driving element and the axle as a driven element.

6. The transport assistance apparatus of claim 5, wherein
the axle is arranged in front of or behind the rotation axis,
a connection portion between the one end of the spring member and the arm member arranged above the rotation axis, and
a distance between the rotation axis and the axle is longer than a distance between the rotation axis and the connection portion in a side view along the left-right direction.

7. The transport assistance apparatus of claim 5, wherein the arm member includes
a connection portion connected to the one end of the spring member and a swing end portion supporting the axle,
the spring member is arranged to extend forward or rearward in the front-rear direction from the other end which is a fixed end toward the one end which is a free end, and
the arm member is arranged to extend from the connection portion toward the swing end portion in a direction opposite to the spring member in the front-rear direction.

8. The transport assistance apparatus of claim 1, wherein
the arm member and the spring member are arranged not to overlap the driving wheel when the transport assistance apparatus is viewed from above.

9. The transport assistance apparatus of claim 1, wherein
the transport assistance apparatus is arranged at a center in the front-rear direction of the lower portion of the bed.
